(19) United States
(12) Patent Application Publication
(10) Pub. No.: US 2021/0351453 A1
(43) Pub. Date: Nov. 11, 2021

(54) HEAT-INSULATING SHEET AND SECONDARY BATTERY USING SAME

(71) Applicant: Panasonic Intellectual Property Management Co., Ltd., Osaka (JP)

(72) Inventor: SHUN AOTA, Osaka (JP)

(21) Appl. No.: 17/277,754

(22) PCT Filed: Oct. 10, 2019
(86) PCT No.: PCT/JP2019/039946

§ 371 Date: Mar. 19, 2021

(30) Foreign Application Priority Data
Jan. 21, 2019 (JP) 2019-007767

(51) Int. Cl. H01M 10/658; H01M 10/613; H01M 10/651; H01M 10/653; H01M 50/209; H01M 50/242; F16L 59/04

(52) U.S. Cl. CPC H01M 10/658; H01M 10/613; H01M 10/651; F16L 59/04; H01M 50/209; H01M 50/242; H01M 10/653

(57) ABSTRACT

A heat-insulating sheet includes a fiber sheet having spaces therein and silica xerogel held in the spaces of the fiber sheet. The heat-insulating sheet includes a first region located at a peripheral portion of the heat-insulating sheet and a second region surrounded by the first region. A compression rate of the second region of the heat-insulating sheet in response to a pressure of 1 MPa applied to the second region is smaller than a compression rate of the first region of the heat-insulating sheet in response to a pressure of 1 MPa applied to the first region. The heat-insulating sheet reduces a compressive strain while maintaining heat insulation performance.

The heat-insulating sheet may be installed in a secondary battery and enhances reliability of the secondary battery against a swell of the battery due to an increase of pressure inside a cell of the battery.

### TECHNICAL FIELD

The present invention relates to insulation heat-insulating sheet and a secondary battery including the heat-insulating sheet for heat insulation.

### BACKGROUND ART

In recent years, needs for energy saving have been increased. Among ways to satisfy such needs are measures for increase energy efficiency by keeping equipment warm. In a secondary battery including battery cells, heat insulation between the battery cells is required in order to prevent one battery cell having become hot from affecting neighboring battery cells. To satisfy this requirement, a heat-insulating sheets excellent for a heat insulation effect is disposed between the battery cells.

PTL 1 discloses a conventional heat-insulating material used as the heat-insulating sheet described above.

### CITATION LIST

### Patent Literature

PTL 1: International Publication WO 2018/003545

### SUMMARY

A heat-insulating sheet includes a fiber sheet having spaces therein and silica xerogel held in the spaces of the fiber sheet. The heat-insulating sheet includes a first region located at a peripheral portion of the heat-insulating sheet and a second region surrounded by the first region. A compression rate of the second region of the heat-insulating sheet in response to a pressure of 1 MPa applied to the second region is smaller than a compression rate of the first region of the heat-insulating sheet in response to a pressure of 1 MPa applied to the first region.

The heat-insulating sheet reduces a compressive strain while maintaining heat insulation performance. The heat-insulating sheet may be installed in a secondary battery and enhances reliability of the secondary battery against a swell of the battery due to an increase of pressure inside a cell of the battery.

### BRIEF DESCRIPTION OF DRAWINGS

FIG. 1 is a cross-sectional view of a heat-insulating sheet according to an exemplary embodiment.

FIG. 2 is a perspective view of the heat-insulating sheet according to the embodiment.

FIG. 3 shows a relation between a density and a compression rate of the heat-insulating sheet according to the embodiment.

FIG. 4A is a cross-sectional view of the heat-insulating sheet according to the embodiment for illustrating a method of manufacturing the heat-insulating sheet.

FIG. 4B is a cross-sectional view of the heat-insulating sheet according to the embodiment for illustrating the method of manufacturing the heat-insulating sheet.

FIG. 4C is a cross-sectional view of the heat-insulating sheet according to the embodiment for illustrating the method of manufacturing the heat-insulating sheet.

FIG. 5 shows a relation between a sheet density and an SiO₂ concentration in aqueous silica solution in the method of manufacturing the heat-insulating sheet according to the embodiment.

FIG. 6 is a cross-sectional view of a secondary battery including the heat-insulating sheets according to the embodiment.

FIG. 7 is a cross-sectional view of another heat-insulating sheet according to the embodiment.

FIG. 8 is a perspective view of the heat-insulating sheet shown in FIG. 7.

### DETAIL DESCRIPTION OF PREFERRED EMBODIMENT

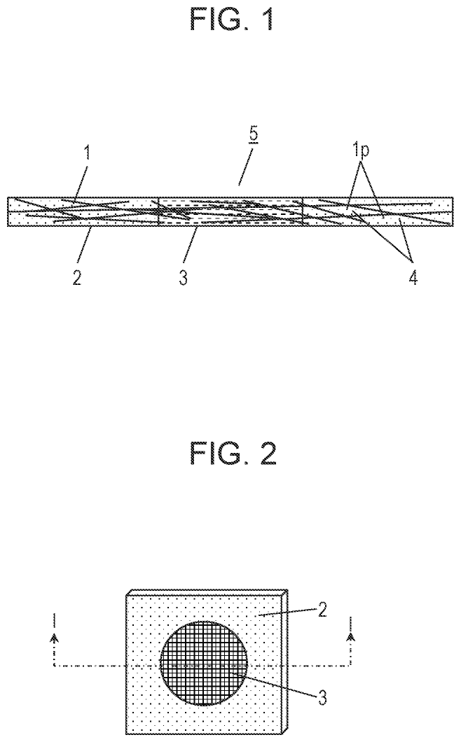

FIGS. 1 and 2 are a cross-sectional and a perspective view of heat-insulating sheet 5 according to an exemplary embodiment, respectively. FIG. 1 shows a cross section of heat-insulating sheet 5 on line I-I shown in FIG. 2. Heat-insulating sheet 5 includes fiber sheet 1 including spaces therein and silica xerogel 4 held in spaces 1p of fiber sheet 1. Heat-insulating sheet 5 includes region 2 located at a circumferential portion, i.e., a peripheral portion of heat-insulating sheet 5, and region 3 surrounded by region 2. In region 2, silica xerogel 4 is held in spaces 1p of fiber sheet 1 such that the sheet has a density of 0.25 g/cm³. Silica xerogel 4 is held in spaces 1p in region 3 of fiber sheet 1 such that the sheet has a density of 0.5 g/cm³. Silica xerogel 4 is thus held in spaces 1p of fiber sheet 1 such that the density of region 2 is smaller than the density of region 3. These densities allows region 2 to exhibit a compression rate of about 35%, and allows region 3 to exhibit a compression rate of about 6%. The compression rate at a certain region of the heat insulating sheet here is a strain ratio of the region in response to pressure of 1 MPa applied to the region of the sheet.

The compression rate in region 3, i.e., the strain ratio in region 3 in response to a certain pressure applied to region 3 is smaller than the compression rate of region 2, i.e., the strain ratio in region 2 in response to the same certain pressure. The compression rate Rp of a particular region (region 2 or 3) of heat-insulating sheet 5 in response to pressure Pn is expressed as Rp=(Ti−Tk)/Ti, where Ti is an initial thickness of heat-insulating sheet 5 in the region, and Tk is a thickness of the sheet while pressure Pn is applied thereto.

Fiber sheet 1 is made of fibers, such as inorganic fibers, resin fibers, or natural product fibers, and has a weight per unit area equal to or larger than 5 g/m² and equal to or smaller than 200 g/m². Silica xerogel 4 is aerogel in a broad sense in which a gel is in a dry state, and may be aerogel even produced by drying process such as supercritical drying. Silica xerogel 4 held in spaces 1p of fiber sheet 1 includes nano-sized spaces therein. Such nano-sized spaces have sizes smaller than the mean free path of air, and suppress convection, thereby reducing thermal conductivity.

In the case where heat-insulating sheet 5 includes only region 2, the sheet provides excellent thermal characteristics on the one hand, but such a large compression rate causing a concern that the compression strength may decrease. In the case where heat-insulating sheet 5 include only region 3, the sheet provides a small compression strength, but causes a concern that the thermal characteristics may decrease. In heat-insulating sheet 5 according to the embodiment, the compression strength increases only at a portion where the compression strength is required, thereby increasing a compression strength while avoiding causing a decrease in the thermal characteristics. In addition, since heat-insulating sheet 5 has a structure made of only two components: fiber sheet 1 and silica xerogel 4, this structure increases the compression strength, as a whole, without largely impairing its heat insulation performance.

Respective central portions of battery cells swell at an end of life of a secondary battery due to, e.g. gas produced inside the battery cells. A heat-insulating sheet including silica xerogel held by a fiber sheet at a uniform density has a small compressive strength. For this reason, the sheet used as a separator between the battery cells may not withstand pressures due to the swell and a large compression strain occurs in a direction of the thickness of the sheet.

Heat-insulating sheet 5 according to the embodiment has a large compression strength, as a whole, without greatly impairing its heat insulation performance as described above.

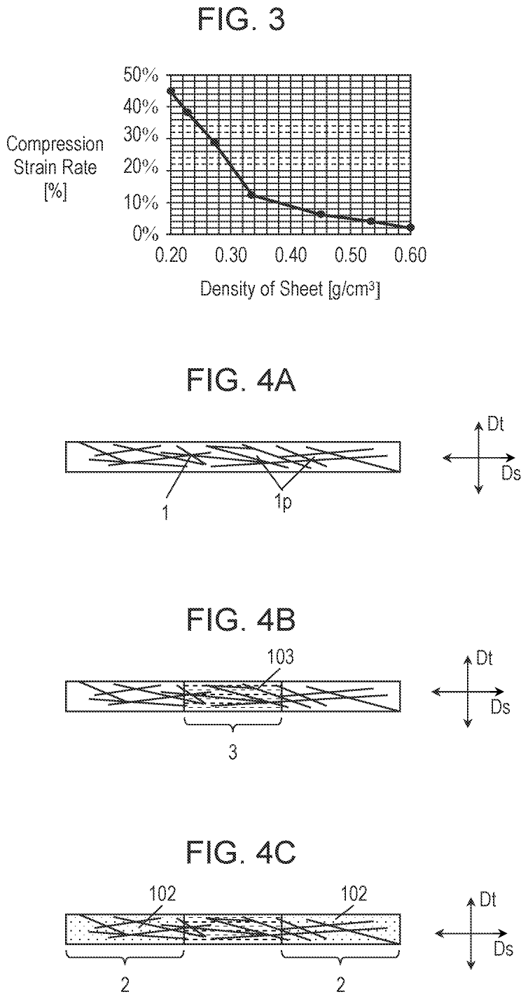

FIG. 3 shows a relation between the density and the compression rate of heat-insulating sheet 5 according to the embodiment. The density of region 2 of heat-insulating sheet 5 smaller than 0.2 g/cm³ prevents fiber sheet 1 from holding silica xerogel 4 securely. The density of region 2 larger than 0.3 g/cm³ degrades its thermal characteristics. For this reason, the density of region 2 of heat-insulating sheet 5 is preferably equal to or larger than 0.2 g/cm³ and equal to or smaller than 0.3 g/cm³. The density of region 3 of heat-insulating sheet 5 smaller than 0.4 g/cm³ degrades its compression strength. The density of region 3 of heat-insulating sheet 5 larger than 0.6 g/cm³ may excessively increase the viscosity of the material of silica xerogel 4, accordingly preventing silica xerogel 4 from impregnating into fiber sheet 1 smoothly. For this reason, the density of region 3 of heat-insulating sheet 5 is preferably equal to or larger than 0.4 g/cm³ and equal to or smaller than 0.6 g/cm³. Regions 2 and 3 with densities different from each other are disposed on the same plane along heat-insulating sheet 5, the densities may gradually change across a border between regions 2 and 3. Such densities changing gradually allow heat-insulating sheet 5 to follow the swelling surfaces of the battery cells, providing advantageous effects on the thermal characteristics and compression strength of heat-insulating sheet 5.

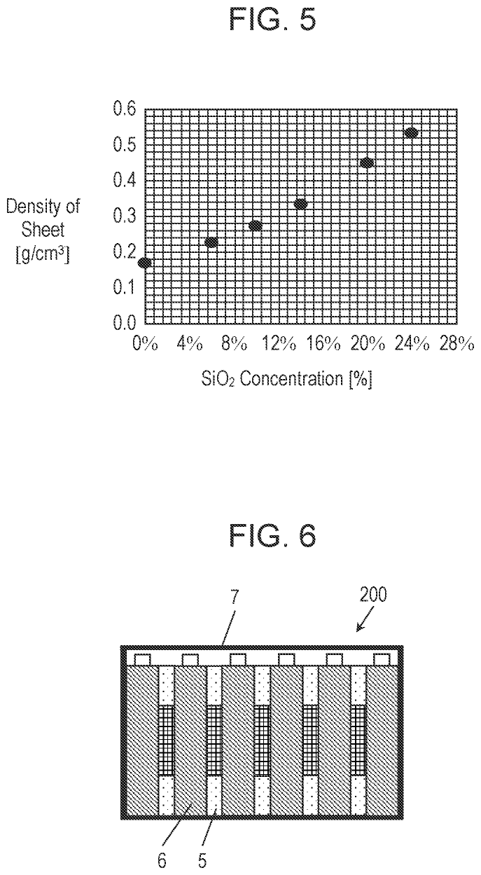

A method of manufacturing heat-insulating sheet 5 according to the embodiment will be described below. FIGS. 4A to 4C are cross-sectional views of heat-insulating sheet 5 for illustrating the method of manufacturing heat-insulating sheet 5. First, a process applying and impregnating silica sol, i.e., material of silica gel 4 to and into fiber sheet 1. FIG. 5 shows a relation of the sheet density against the concentration of SiO₂ in an aqueous silica solution contained in silica gel 4. First, fiber sheet 1 shown in FIG. 4A which includes spaces 1p therein is prepared. Silica sol 103 is prepared by mixing an aqueous silica solution with 20% of SiO₂ and carbonic acid ester as a gelling agent. Next, as shown in FIG. 4B, silica sol 103 is applied to a portion of fiber sheet 1 constituting region 3 of heat-insulating sheet 5 by dripping, thereby impregnating spaces 1p in region 3 of fiber sheet 1 with the silica sol. The aqueous silica solution contain water glass and alkoxysilane. The carbonic acid ester may be dimethyl carbonate or ethylene carbonate preferably easily dissolved in water. The weight of dripped silica sol 103 that contains the aqueous silica solution with 20% of SiO₂ is adjusted to control the volume of the portion of fiber sheet 1 constituting region 3. At this moment, the silica sol dripped onto fiber sheet 1 uniformly permeates into the sheet and spreads in direction Dt of the thickness due to the gravity and in in-plane directions Ds perpendicular to direction Dt due to diffusion of the silica sol, thereby being held in a cylindrical shape in fiber sheet 1. Silica sol 102 is prepared by mixing an aqueous silica solution with 6% of SiO₂ and carbonic acid ester as a gelling agent. After the application of silica gel 103 to region 3 followed by the impregnation and then after the gelling of silica sol 102 has proceeded, silica sol 102 is applied, by dripping, to a portion of fiber sheet 1 constituting region 2, thereby impregnating spaces 1p of fiber sheet 1 at region 3, as shown in FIG. 4C. Then, silica sol 102 is gelled. After that, the skeleton of a nano-sized porous structure of silica xerogel 4 made of having-gelled silica sols 102 and 103 grows. Then, silica xerogel 4 is subjected to hydrophobic treatment. After that, silica xerogel 4 and fiber sheet 1 are dried under normal pressure, thereby providing heat-insulating sheet 5. The drying is not necessarily the normal pressure drying. The sheet may be dried by another drying method, such as supercritical drying.

FIG. 6 is a cross-sectional view of secondary battery 200 including heat-insulating sheets 5 according to the embodiment. Secondary battery 200 includes case 7, battery cells 6 fixed in case 7, and heat-insulating sheets 5 disposed as separators between battery cells 6. The thickness of each of heat-insulating sheets 5 is about 1 mm. When battery cell 6 among battery cells 6 has high temperatures, heat-insulating sheet 5 serving as a separator prevents heat conduction, thereby reducing heat to transmit from battery cell 6 with high temperature to neighboring battery cells 6. This provides secondary battery 200 with high reliability. Each of battery cells 6 are repetitively charged and discharged, and produce gas filling up inside of battery cells 6. Due to the internal pressure of the gas, battery cells 6 swell substantially at respective center portions of contact surfaces of the cells contacting heat-insulating sheet 5. The swelling of battery cells 6 causes the pressure applied to heat-insulating sheet 5 up to about 1 MPa. In consideration of an influence on a reaction force to battery cell 6, the compression rate under the applied pressure is preferably equal to or smaller than 10%. In conventional heat-insulating sheets, a compression rate thereof in response to a pressure of 1 MPa applied to their central portions may range from about 15% to 20% in the direction of the thickness. Consequently, the compression rate becomes larger than 10%, and provides adverse effects of reducing the reaction force to battery cell 6. In contrast, heat-insulating sheet 5 including region 3 at a central portion thereof with a density equal to or larger than 0.4 g/cm³ and equal to or smaller than 0.6 g/cm³ reduces the compression rate to equal to or smaller than 10% under an applied pressure of 1 MPa to the central portion. This configuration reduces the influence of swelling of battery cell 6 while increasing the heat insulating property.

In the case where battery cells 6 are continuously connected to each other alternately via heat-insulating sheets 5 with two surfaces of each sheet contacting adjacent battery cells 6, the shape of region 3 of heat-insulating sheets 5 according to the embodiment may be a cylindrical shape, a cubic shape, or a column shape, such as a polyhedral column shape having wide surfaces (basal surfaces) parallel to each other opposite to each other.

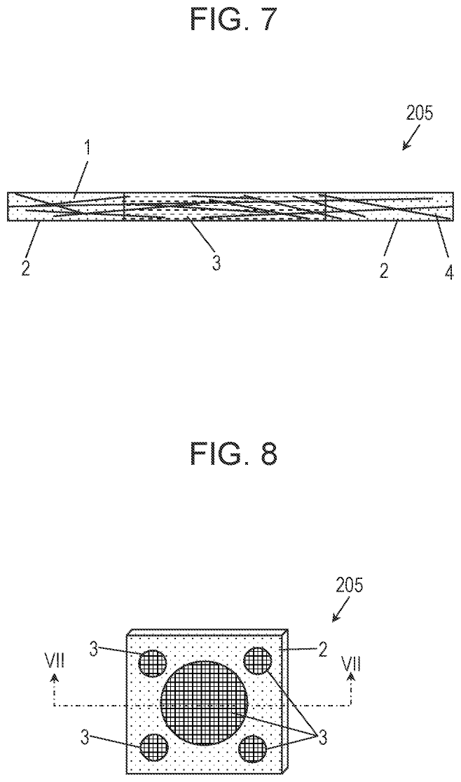

FIGS. 7 and 8 are a cross-sectional and a perspective view of another heat-insulating sheet 205 according to the embodiment, respectively. FIG. 7 shows a cross section of heat-insulating sheet 205 at line VII-VII shown in

FIG. 8. In heat-insulating sheet 205, region 2 surrounds regions 3. Plural three-dimensional bodies constituting regions 3 are arranged on one plane. The shapes of the three-dimensional bodies may be a combination of the shapes described above. However, at least one of regions 3 includes the geometric center of gravity of the sheet surface. The central portion of battery cell 6 swelling is located at a central portion of the surface of the sheet contacting the cell. Therefore, region 3 with a large compression strength includes the geometric center of gravity of the sheet surface reduces the influence of swelling of battery cell 6.

### REFERENCE MARKS IN THE DRAWINGS

1 fiber sheet 1
2 region (first region)
3 region (second region)
4 silica xerogel
5 heat-insulating sheet
6 battery cell
7 case

1. A heat-insulating sheet comprising:
a fiber sheet having spaces therein; and
silica xerogel held in the spaces of the fiber sheet, wherein the heat-insulating sheet includes a first region located at a peripheral portion of the heat-insulating sheet and a second region surrounded by the first region, and
a compression rate of the second region of the heat-insulating sheet in response to a pressure of 1 MPa applied to the second region is smaller than a compression rate of the first region of the heat-insulating sheet in response to a pressure of 1 MPa applied to the first region.

2. The heat-insulating sheet according to claim 1, wherein
a density of the first region of the heat-insulating sheet is equal to larger than 0.2 g/cm³ and equal to or smaller than 0.3 g/cm³, and
a density of the second region of the heat-insulating sheet is equal to or larger than 0.4 g/cm³ and equal to or smaller than 0.6 g/cm³.

3. The heat-insulating sheet according to claim 1, wherein the second region includes a geometric center of gravity of the heat-insulating sheet.

4. A secondary battery, comprising:
a case;
a plurality of battery cells fixed in the case; and
a heat-insulating sheet disposed between the plurality of battery cells, wherein
the heat-insulating sheet comprises the heat-insulating sheet according to claim 1.
